(19) United States
(12) Patent Application Publication
(10) Pub. No.: US 2007/0053317 A1
(43) Pub. Date: Mar. 8, 2007

(54) Methods and systems for monitoring a wireless broadband base station

(75) Inventor: Todd E. Sormunen, New Smyrna Beach, FL (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation, Wilmington, DE (US)

(21) Appl. No.: 11/222,067

(22) Filed: Sep. 8, 2005

(51) Int. Cl. H04Q 7/00

(52) U.S. Cl. 370/328; 370/401

(57) ABSTRACT

Systems and methods are disclosed for monitoring a wireless broadband base station in a wireless broadband system. The disclosed systems and methods may include polling at least one wireless broadband base station in the wireless broadband system. Furthermore, the disclosed systems and methods may include gathering alarm condition information from the polled at least one wireless broadband base station and evaluating the alarm condition information. Moreover, the disclosed systems and methods may include reporting the alarm condition information if evaluating the alarm condition information indicates that the alarm condition information comprising one of critical or major.

### BACKGROUND OF THE INVENTION

I. Field of the Invention

The present invention generally relates to methods and systems for monitoring a wireless broadband base station in a wireless broadband system. More particularly, the present invention relates to monitoring a wireless broadband base station, for example, to improve service quality for wireless broadband users.

II. Background Information

Service providers provide wireless broadband service using wireless broadband base stations in a wireless broadband system. In order to provide this service, the wireless broadband base stations need to be monitored. The monitoring is necessary to improve service quality to wireless broadband users.

The conventional monitoring strategy is to use an element management system (EMS) server to manually monitor a wireless broadband base station. The EMS server can be used for troubleshooting and for configuring wireless broadband base stations. The EMS server, however, does not provide an adequate automated alarm monitoring and reporting process. In some cases, alarm conditions that affect users are not reported using the EMS server alone. For example, alarms are collected by a technician who must complete the following steps to gather alarm information: i) establish a connection to the EMS server; ii) launch an EMS client; iii) select an individual broadband base station; iv) view alarms; v) repeat steps iii) and iv) until all broadband base stations have been checked; vi) close the EMS client; vii) close the connection to the EMS server; and viii) contact an on-call technician and relay the alarm information gathered. This often causes problems because the conventional strategy is time intensive. If more than a few broadband base stations are in operation, the time it takes to view alarm details on each base station can be extensive.

In view of the foregoing, there is a need for methods and systems for monitoring a wireless broadband base station in a wireless broadband system more optimally. Furthermore, there is a need for monitoring a wireless broadband base station, for example, to improve service quality for wireless broadband users.

### SUMMARY OF THE INVENTION

Consistent with embodiments of the present invention, systems and methods are disclosed for monitoring a wireless broadband base station in a wireless broadband system.

In accordance with one embodiment, a method for monitoring wireless broadband base stations in a wireless broadband system comprises polling at least one wireless broadband base station in the wireless broadband system, gathering alarm condition information from the polled at least one wireless broadband base station, and evaluating the alarm condition information.

According to another embodiment, a system for monitoring wireless broadband base stations in a wireless broadband system comprises a memory storage for maintaining a database and a processing unit coupled to the memory storage, wherein the processing unit is operative to poll at least one wireless broadband base station in the wireless broadband system, gather alarm condition information from the polled at least one wireless broadband base station, and evaluate the alarm condition information.

In accordance with yet another embodiment, a computer-readable medium which stores a set of instructions which when executed performs a method for monitoring wireless broadband base stations in a wireless broadband system, the method executed by the set of instructions comprising polling at least one wireless broadband base station in the wireless broadband system, gathering alarm condition information from the polled at least one wireless broadband base station, and evaluating the alarm condition information.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary wireless broadband base station monitoring system consistent with an embodiment of the present invention;

FIG. 2 is a block diagram of an exemplary monitoring server consistent with an embodiment of the present invention; and

FIG. 3 is a flow chart of an exemplary method for monitoring a wireless broadband base station consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with embodiments of the present invention monitor wireless broadband base stations. The conventional monitoring strategy is deficient because it is time intensive. For example, if more than a few base stations are in operation, the time it takes to view alarm details on each base station is extensive. Consistent with embodiments of the present invention, these deficiencies are resolved by using an automated alarm monitoring system. This solution provides a way to monitor wireless broadband base stations continuously. The monitoring system is automated, collecting alarm messages and reporting the messages to technicians who can respond, if necessary, to resolve alarm conditions present on the wireless broadband base stations.

Consistent with embodiments of the present invention, a monitoring server, accessible through the internet or a private network, runs an alarm monitoring software module. The software module may run continuously, polling wireless broadband base stations at a predefined and configurable time interval. The monitoring server connects to each wireless broadband base station, in turn, through a telnet session, for example, gathering alarm condition information and recording the information in a file on the monitoring server. The software module terminates the telnet session to a current wireless base station, after gathering alarm information, and establishes a telnet connection to another next wireless broadband base. This process continues until all wireless broadband base stations are polled.

A virtual private network (VPN) may be used by the monitoring server to connect to the wireless broadband base stations. The VPN is used to establish a secure connection to each base station and then to collect alarm condition information. No additional network facilities may be required to provide the alarm monitoring. The polling portion is also an important feature of the monitoring system. By polling the base stations, an accurate rendering of operation conditions is provided. Also, by automating all portions of the alarm monitoring system, very little human intervention is needed.

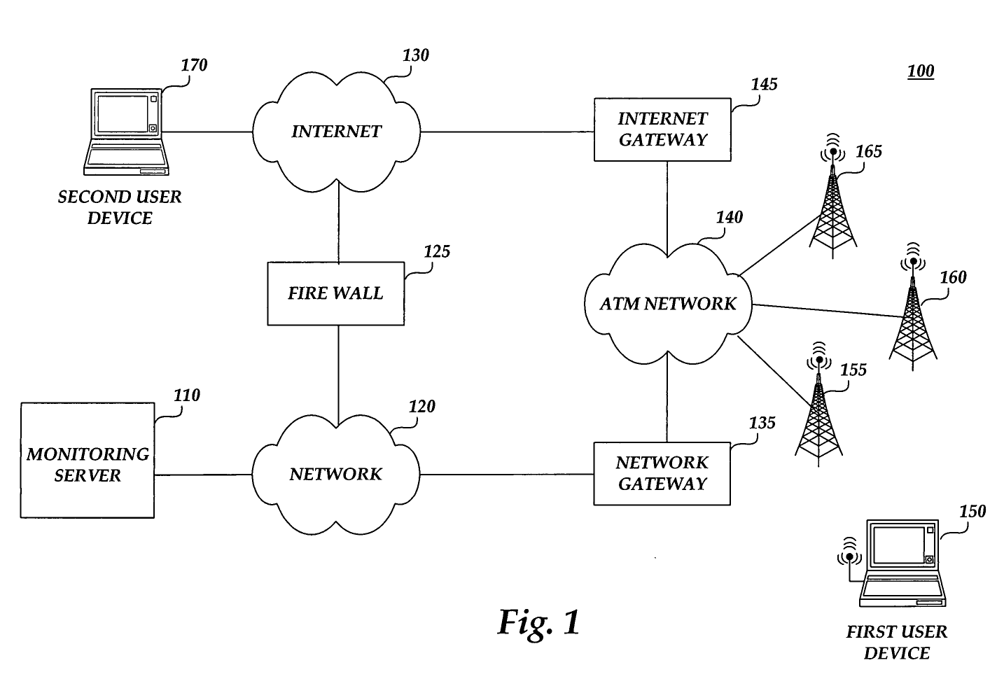

FIG. 1 is a block diagram of an exemplary wireless broadband base station monitoring system 100 consistent with an embodiment of the present invention. Using system 100, a service provider provides wireless broadband service and monitors the performance of certain elements in system 100. As illustrated in the block diagram of FIG. 1, wireless broadband base station monitoring system 100 includes a monitoring server 110 and a network 120 that connects to the internet 130 through a fire wall 125. Network 120 also connects to an asynchronous transfer mode (ATM) network 140 through a network gateway 135 (e.g., a router.)

A first user device 150 communicates with a second user device 170 over internet 130. In order to connect to internet 130, first user device 150 subscribes to the service provider who provides wireless broadband service to first user device 150. Using the service provider's wireless broadband service, first user device 150 communicates wirelessly with any of wireless broadband base stations 155, 160, and 165. Wireless broadband base stations 155, 160, and 165, in turn, connect to ATM network 140 that connects to internet 130 through internet gateway 145 (e.g., a router.) Consistent with an embodiment of the present invention, monitoring server 110 monitors the performance of wireless broadband base stations 155, 160, and 165.

An embodiment consistent with the invention comprises a system for monitoring enterprise file currency. The system comprises a memory storage for maintaining a database and a processing unit coupled to the memory storage. The processing unit is operative to create a currency check and notification configuration. In addition, the processing unit is operative to execute a currency check based on the currency check and notification configuration and report the results of the currency check.

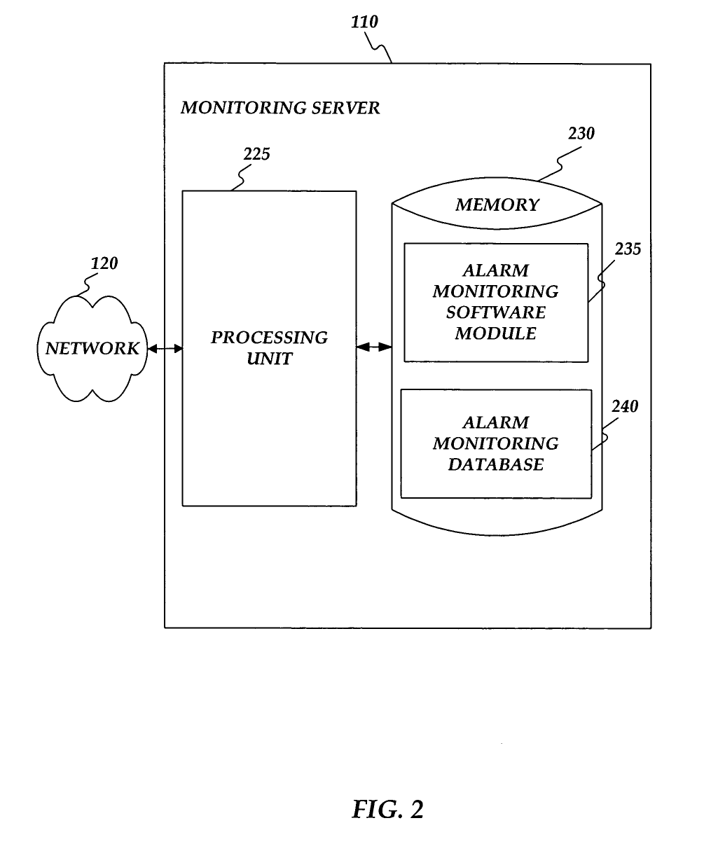

Consistent with an embodiment of the present invention, the aforementioned memory, processing unit, and other components may be implemented in a monitoring server, such as monitoring server 110 of FIG. 1. FIG. 2 shows monitoring server 110 in more detail. Any suitable combination of hardware, software, and/or firmware may be used to implement the memory, processing unit, or other components. The aforementioned system and servers are exemplary and other systems and servers may comprise the aforementioned memory, processing unit, or other components, consistent with embodiments of the present invention.

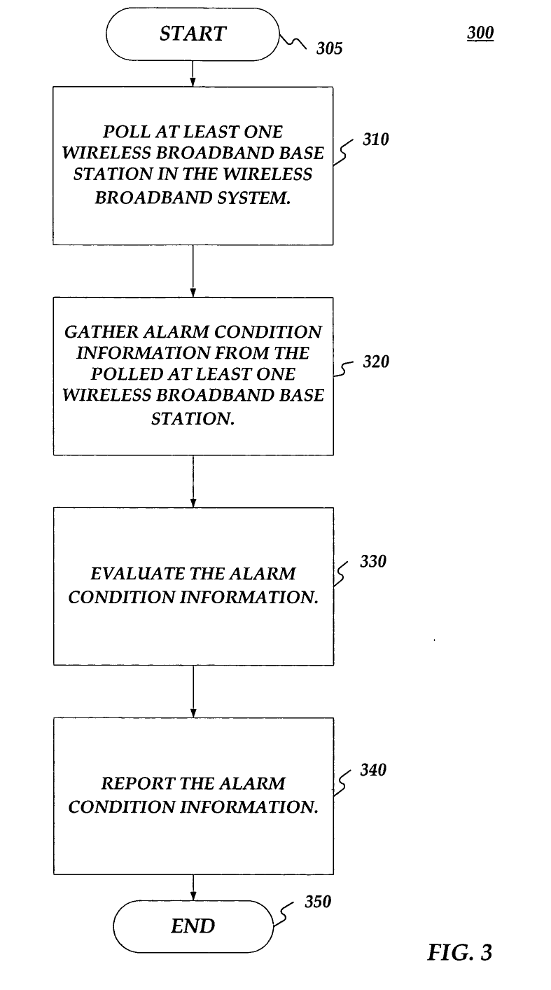

As illustrated in the block diagram of FIG. 2, monitoring server 110 includes a processing unit 225 and a memory 230. Memory 230 includes an alarm monitoring software module 235 and an alarm monitoring database 240. Software module 235 residing in memory 230 is executed on processing unit 225 and may access alarm monitoring database 240. While executing on processing unit 225, software module 235 performs embodiments of the invention including, for example, one or more of the stages of method 300 described below with respect to FIG. 3.

Monitoring server 110 (“the server”) included in system 100 may be implemented using a personal computer, network computer, mainframe, or other similar microcomputer-based workstation. The server may though comprise any type of computer operating environment, such as hand-held devices, multiprocessor systems, microprocessor-based or programmable sender electronic devices, minicomputers, mainframe computers, and the like. The server may also be practiced in distributed computing environments where tasks are performed by remote processing devices. Furthermore, any of the server may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the server may comprise other systems or devices.

Network 120 may comprise, for example, a VPN, a local area network (LAN), or a wide area network (WAN). Such networking environments are commonplace in offices, enterprise-wide computer networks, intranets, and the Internet, and are known by those skilled in the art. When a LAN is used as network 120, a network interface located at any of the processors may be used to interconnect any of the processors. When network 120 is implemented in a WAN networking environment, such as the Internet, the processors may typically include an internal or external modem (not shown) or other means for establishing communications over the WAN. Further, in utilizing network 120, data sent over network 120 may be encrypted to insure data security by using known encryption/decryption techniques. Furthermore, network 120 may also comprise a virtual private (VPN), operated, for example over a public network such as the network.

In addition to utilizing a wire line communications system as network 120, a wireless communications system, or a combination of wire line and wireless may be utilized as network 120 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission. For example, the processors may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, another RF communication interface, and/or an optical interface.

FIG. 3 is a flow chart setting forth the general stages involved in an exemplary method 300 consistent with the invention for monitoring a wireless broadband base station using system 100 of FIG. 1. Exemplary ways to implement the stages of exemplary method 300 will be described in greater detail below. Exemplary method 300 begins at starting block 305 and proceeds to stage 310 where monitoring server 110 polls at least one wireless broadband base station (e.g. wireless broadband base stations 155, 160, or 165) in the wireless broadband system. For example, monitoring server 110 accesses network 120. Network 120 may comprise a private network controlled by the service provider. Once connected to network 120, monitoring server 110 accesses ATM network 140 through network gateway 135. After monitoring server 110, accesses ATM network 140, it can then connect to any of wireless broadband base stations 155, 160, and 165. When monitoring server 110 accesses ATM network 140, it can execute software module 235, which may run continuously, polling wireless broadband base stations 155, 160, and 165 at a predefined and configurable time interval.

From stage 310, where monitoring server 110 polls the at least one wireless broadband base station in the wireless broadband system, exemplary method 300 advances to stage 320 where monitoring server 110 gathers alarm condition information from the polled at least one wireless broadband base station. For example, monitoring server 110 connects to any of wireless broadband base stations 155, 160, and 165 through a telnet session, for example, gathering alarm condition information and recording the gathered alarm condition information in alarm monitoring database 240. Software module 235 may terminate the telnet session to the current wireless base station (e.g. wireless broadband base station 155.) After gathering alarm condition information from the current wireless base station, monitoring server 110 then establish a telnet connection to a next wireless broadband base (e.g. wireless broadband base station 160.) This process continues until all wireless broadband base stations are polled and any and all alarm condition information is gathered. This process may be represented continuously.

Once monitoring server 110 gathers alarm condition information from the polled at least one wireless broadband base station in stage 320, exemplary method 300 continues to stage 330 where monitoring server 110 evaluates the gathered alarm condition information. For example, the alarm condition information may comprise one of the following alarm types: critical, major, or warning. The critical alarm type indicates that customers are out of service. The major alarm type indicates that the wireless broadband system is affected with a problem. And the warning alarm type indicates a potential problem exists with the wireless broadband system. For example, wireless broadband base station 160 may report that a T1 line between it and internet 130 is down. Because another T1 line may still be in service between wireless broadband base station 160 and internet 130, this alarm condition may be considered major because service is affected, but all customers may still be served. If, however, all T1 lines between wireless broadband base station 160 and internet 130 are down, this alarm condition may be considered critical because no customers may be served by wireless broadband base station 160. A warning alarm type may be gathered, if, for example, a gate in a fence surrounding wireless broadband base station 160 was left open. The aforementioned alarm conditions and types are exemplary and others may be used.

After monitoring server 110 evaluates the alarm condition information in stage 330, exemplary method 300 proceeds to stage 340 where monitoring server 110 reports the alarm condition information. Monitoring server 110 may report the alarm condition information if the alarm condition information evaluation indicates that the alarm condition information comprises the critical or the major type. For example, if a critic alarm condition was gathered on wireless broadband base station 160, monitoring server 110 may report this to a service technician. The service technician may then be dispatched to address this alarm condition on wireless broadband base station 160. After monitoring server 110 reports the alarm condition information in stage 340, exemplary method 300 then ends at stage 350.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention is described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for monitoring wireless broadband base stations in a wireless broadband system, the method comprising:
polling at least one wireless broadband base station in the wireless broadband system;
gathering alarm condition information from the polled at least one wireless broadband base station; and
evaluating the alarm condition information.

2. The method of claim 1, wherein polling the at least one wireless broadband base station further comprises polling the at least one wireless broadband base station at predefined time period.

3. The method of claim 1, wherein polling the at least one wireless broadband base station further comprises polling the at least one wireless broadband base station through a virtual private network.

4. The method of claim 1, wherein gathering the alarm condition information further comprises:
connecting to the at least one wireless broadband base station through a telnet session;
receiving the alarm condition information; and
saving the alarm condition information.

5. The method of claim 1, wherein evaluating the alarm condition information further comprises determining if the alarm condition information comprising one of the following alarm types: critical, major, and warning.

6. The method of claim 5, wherein the critical alarm type indicates that customers are out of service, the major alarm type indicates that the wireless broadband system is affected with a problem, and the warning alarm type indicates a potential problem exists with the wireless broadband system.

7. The method of claim 1, further comprising reporting the alarm condition information if evaluating the alarm condition information indicates that the alarm condition information comprises one of the following alarm types: critical and major.

8. A system for monitoring wireless broadband base stations in a wireless broadband system, the system comprising:
a memory storage for maintaining a database; and
a processing unit coupled to the memory storage, wherein the processing unit is operative to:
poll at least one wireless broadband base station in the wireless broadband system;
gather alarm condition information from the polled at least one wireless broadband base station; and
evaluate the alarm condition information.

9. The system of claim 8, wherein the processing unit being operative to poll the at least one wireless broadband base station further comprises the processing unit being operative to poll the at least one wireless broadband base station at predefined time period.

10. The system of claim 8, wherein the processing unit being operative to gather the alarm condition information further comprises the processing unit being operative to:
connect to the at least one wireless broadband base station through a telnet session;
receive the alarm condition information; and
save the alarm condition information.

11. The system of claim 8, wherein the processing unit being operative to evaluate the alarm condition information further comprises the processing unit being operative to determine if the alarm condition information comprising one of the following alarm types: critical, major, and warning.

12. The system of claim 11, wherein the critical alarm type indicates that customers are out of service, the major alarm type indicates that the wireless broadband system is affected with a problem, and the warning alarm type indicates a potential problem exists with the wireless broadband system.

13. The system of claim 8, further comprising the processing unit being operative to report the alarm condition information if the alarm condition information indicates that the alarm condition information comprises one of the following alarm types: critical and major.

14. A computer-readable medium which stores a set of instructions which when executed performs a method for monitoring wireless broadband base stations in a wireless broadband system, the method executed by the set of instructions comprising:
polling at least one wireless broadband base station in the wireless broadband system;
gathering alarm condition information from the polled at least one wireless broadband base station; and
evaluating the alarm condition information.

15. The computer-readable medium of claim 14, wherein polling the at least one wireless broadband base station further comprises polling the at least one wireless broadband base station at predefined time period.

16. The computer-readable medium of claim 14, wherein polling the at least one wireless broadband base station further comprises polling the at least one wireless broadband base station through a virtual private network.

17. The computer-readable medium of claim 14, wherein gathering the alarm condition information further comprises:
connecting to the at least one wireless broadband base station through a telnet session;
receiving the alarm condition information; and
saving the alarm condition information.

18. The computer-readable medium of claim 14, wherein evaluating the alarm condition information further comprises determining if the alarm condition information comprising one of the following alarm types: critical, major, and warning.

19. The computer-readable medium of claim 18, wherein the critical alarm type indicates that customers are out of service, the major alarm type indicates that the wireless broadband system is affected with a problem, and the warning alarm type indicates a potential problem exists with the wireless broadband system.

20. The computer-readable medium of claim 14, further comprising reporting the alarm condition information if evaluating the alarm condition information indicates that the alarm condition information comprises one of the following alarm types: critical and major.
